(19) United States
(12) Patent Application Publication
(10) Pub. No.: US 2010/0275739 A1
(43) Pub. Date: Nov. 4, 2010

(54) SINGLE PIECE ROTARY WRENCHING TOOL

(75) Inventor: Herbert G. HART, Sunnyvale, CA (US)

Correspondence Address: TILLMAN WRIGHT, PLLC, P.O. BOX 49309, CHARLOTTE, NC, 28277-0076, US

(73) Assignee: EDISON NATION, LLC, Charlotte, NC (US)

(21) Appl. No.: 12/836,960

(22) Filed: Jul. 15, 2010

Related U.S. Application Data
(63) Continuation of application No. 12/542,095, filed on Aug. 17, 2009.
Application No. 12/542,095 is a continuation of application No. 11/796,350, filed on Apr. 26, 2007, now abandoned.
(60) Provisional application No. 60/797,190, filed on May 2, 2006.

(51) Int. Cl. B25B 13/06; B25B 13/00

(52) U.S. Cl. 81/124.4; 81/125.1

(57) ABSTRACT

A rotary wrenching tool used on polygonal nuts, bolts and screws is disclosed. More particularly, the wrenching tool is a single piece rotary wrenching tool with a uniform interior having no moving parts and consisting of six or twelve inwardly projecting lobes of the same size that enable the wrench or socket to exert pressure on the flats of hexagonal objects away from the corners. This invention further relates to a duplex wrench operable on hexagonal fasteners measured by the metric, inch, or both systems. Within a defined range in one wrench, each wrench secures hexagonal objects measured by both inch and metric systems.

### CROSS REFERENCE TO RELATED APPLICATIONS

The present application is a U.S. continuation patent application of, and claims priority under 35 U.S.C. §120 to, U.S. nonprovisional patent application Ser. No. 12/542,095, filed Aug. 17, 2009, and published as US 2009/0301270 A1 on Dec. 10, 2009, which '095 application is a continuation patent application of, and claims priority under 35 U.S.C. §120 to, U.S. nonprovisional patent application Ser. No. 11/796,350, filed Apr. 26, 2007, and published as US 2008/0105093 A1 on May 8, 2008, which '350 application is a nonprovisional of, and claims priority under 35 U.S.C. §119(e) to, U.S. Provisional Patent Application No. 60/797,190 filed May 2, 2006. Each of the patent applications and patent application publications listed hereinabove is hereby incorporated herein by reference in its entirety.

### BACKGROUND OF THE INVENTION

For many years, traditional wrenches have been widely used. Traditional wrenches are frequently found inconvenient, inefficient, cumbersome and new wrenches are highly demanded. For instance, wrenches having closed openings with planar engagement surfaces often result in stress being applied to a hexagonal fastener and thus cause deformation of the fastener as well as providing inefficient torquing ability. Prior art wrenches having closed openings with curved engagement surfaces are known. See U.S. Pat. No. 4,930,378 to Colvin. Although the prior art wrenches include six-point and twelve-point versions, problems with stress distribution are not resolved. Furthermore, the twelve-point version is configured using either metric or inch sizing, rather than both as in a duplex system. Ruzicka et al. discloses rotary wrenching tools capable of wrenching fastener heads in various measuring systems (U.S. Pat. No. 5,388,486. to Ruzicka et al.), but does not disclose a duplex system for both metric and inch sizes. Heberlie discloses ornamental designs for a double-ended box wrench showing the contour of the wrench heads. U.S. Pat. No. D303,069. The invention, however, discloses a double-ended one-sided crown. As the DIYers encounter an increasing number of metric fastener and diminishing percentage of inch sizes, they are required to have two sets of wrenches, for both inch and metric sizes, which are cumbersome, weighty and costly in investment.

### SUMMARY OF THE INVENTION

In various embodiments, one or more of the problems have been reduced or eliminated.

In one embodiment, duplex open end and duplex box wrench are paired. Although the head of the open end is significantly smaller in profile than traditional wrenches, the paired crowns and the tapered internal guide adds tangential strength to the wrench head thereby permitting a slight reduction in the thickness of the wall of the both open and box wrenches. More noticeable is the smaller profile of the open end version, which has jaws that are more blunt than those of conventional wrenches. Although the wrenches are paired, the head is less than twice as thick as traditional wrenches. The tapered internal guide increases the offset quality of both end and box crowns.

In another embodiment, the box crown can be either six or twelve lobes. In one embodiment, the open end has four lobes to contact the fastener and thus distributes the stresses over the four flats of the hex nut. This decreases deformation of the fastener and inefficient torquing ability.

Another advantage of the present invention is compactness. Compactness of the present invention enables the duplex wrench to operate in tighter spaces than most traditional wrenches can do. The present invention also assures optimum contact on and around the hex while the depth of the crowns is minimized. The tapered internal guide prevents the crown from slipping past the hex.

In another embodiment, the lip provides perfect alignment between wrench and hex because of the bottoming out of the hex against the guide.

Another advantage of this single piece rotary wrenching tool with a tapered internal guide is that it provides sufficient space for the shaft of a hex bolt to pass through. The operator can nest a hex nut in the crown of the duplex wrench and carry it to a bolt in a different place to reach or to the underside of an object, making dropped and lost nuts less of a problem. The wide range of hexes that can be accommodated by the duplex set makes these unique tools an appealing, light-weight addition to a handy emergency kit or other tool box. With four sizes on each wrench it is easy to pick the right one for the job. This eliminates the need for the user to gather a bundle of wrenches before beginning a job. The concept of combining double crowns with a tapered internal guide can be applied to other related tools, such as drive socket, crow foot, nut driver, and flare nut and ratchet wrenches.

In another embodiment, two sets of duplex wrenches, both inch and metric, on back to back crowns, provide the DIYers with additional benefits. The pairing of inch and metric sizes dramatically reduces the number of wrenches needed to work on both measuring systems. They are not required to have or carry a toolbox of mixed wrenches. The duplex three pack enables the DIYers to operate on twenty-four metric and inch size hex fasteners. This also minimizes guesswork on choosing the right size wrench. Another advantage of the present invention is that less weight and metal are required in constructing a duplex wrench of the present invention than traditional wrenches.

The above and other objects, features, and advantages of the present invention will become more readily understood and appreciated from a consideration of the following detailed description of the preferred embodiment when taken together with the accompanying drawings, which, however, should not be taken as limitative to the present invention but for elucidation and explanation only.

### BRIEF DESCRIPTION OF THE DRAWINGS

Embodiments of the invention are illustrated in the figures. However, the embodiments and figures are illustrative rather than limiting; they provide examples of the invention.

FIG. 1A depicts a traditional open end wrench.

FIG. 1B depicts a traditional box wrench.

FIG. 2 illustrates a schematic view of a duplex open wrench according to one embodiment of the present invention.

FIG. 3 illustrates a schematic view of a duplex box wrench according to one embodiment of the present invention.

FIGS. 4A, 4B, 4C & 4D depicts a duplex box wrench according to one embodiment of the present invention.

FIG. 5 depicts a duplex wrench according to one embodiment of the present invention.

FIGS. 6A, 6B & 6C depict a schematic view of a duplex box wrench according to one embodiment of the present invention.

FIG. 7A illustrates a profile view of a duplex wrench having both metric and inch sizes according to one embodiment of the present invention.

FIG. 7B illustrates a plain view of the metric and inch sizes contacting lobes of the crown.

FIG. 8 depicts a duplex wrench having inch sizes according to one embodiment of the present invention.

FIG. 9 depicts a duplex wrench having metric sizes according to one embodiment of the present invention.

FIGS. 10A & 10B depicts an open end duplex wrench according to one embodiment of the present invention.

### DETAILED DESCRIPTION OF THE INVENTION

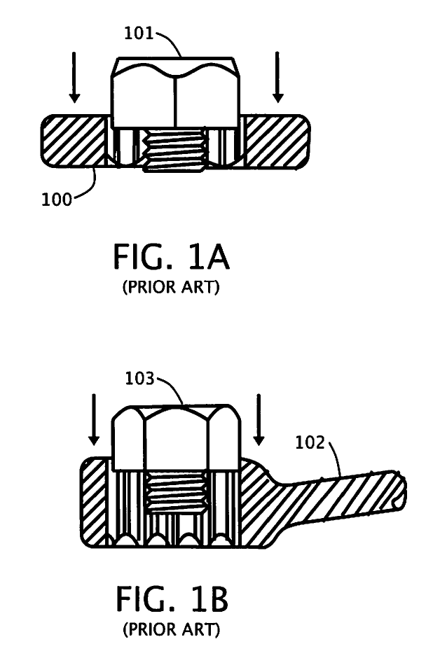

FIG. 1A depicts a traditional open end wrench. A traditional open end wrench 100 slips by when the user applies it on a hex fastener 101.

FIG. 1B depicts a traditional box wrench. A traditional box wrench 102 makes a partial contact with a hex fastener 103.

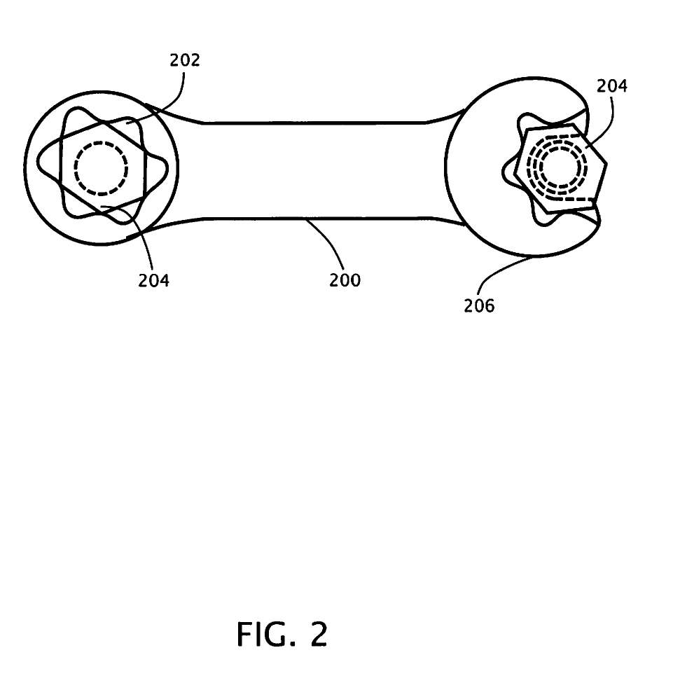

FIG. 2 illustrates a schematic view of a duplex open wrench 200 according to one embodiment of the present invention. In FIG. 2, six inwardly projecting lobes 202 of the same size disposed within a uniform interior of the duplex wrench 200 enable the wrench 200 to exert pressure on flat sides (i.e. flats) of a hexagonal object 204. The head 206 of the duplex open wrench 200 includes a crown having four faces to contact the hexagonal object 204 and thus distribute the stresses over four hex flats of hexagonal object 204.

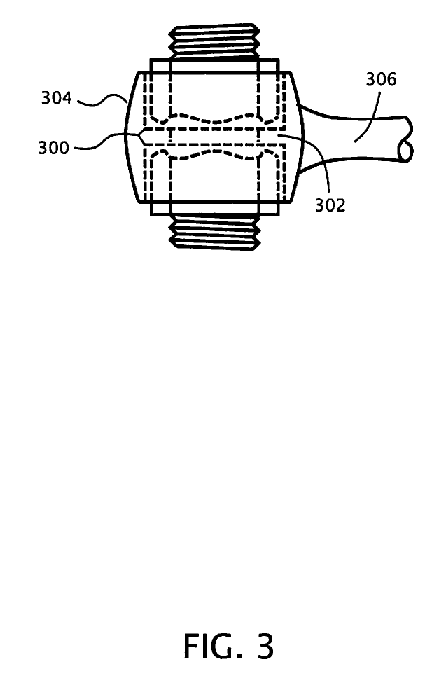

FIG. 3 illustrates a schematic view of a duplex box wrench according to one embodiment of the present invention. A wrench includes a head 304 and a shank 306. The head includes a two-sided crown 300 and a tapered internal guide 302. The paired crowns 300 and the tapered internal guide 302 add strength to the wrench head 304, thereby permitting a slight reduction in the thickness of the box wall of the wrench head 304. Each of the paired crowns 300 can be used as a basket to carry nuts to remote areas or to inverted bolts. The box crown can include either six or twelve lobes.

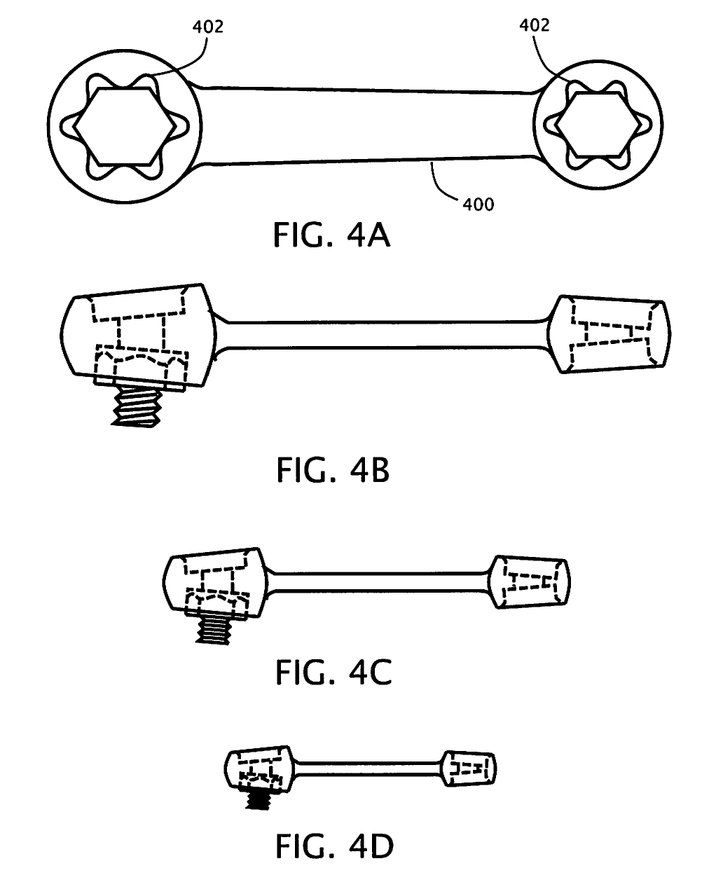

FIG. 4A depicts a schematic view of a duplex box wrench according to one embodiment of the present invention. A wrench with six inwardly projecting lobes 402 of the same size within a uniform interior of the duplex wrench 400 is disclosed.

FIGS. 4B through 4D depict duplex box wrench sets according to the present invention.

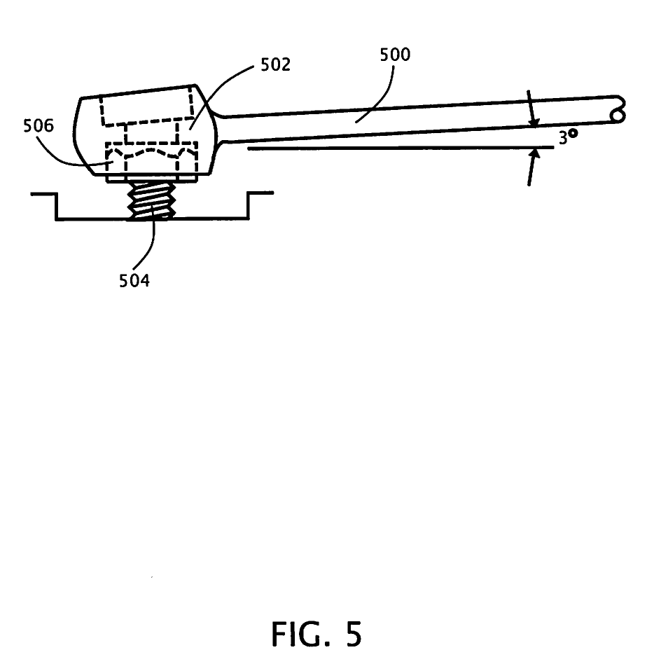

FIG. 5 depicts a duplex wrench 500 according to one embodiment of the present invention. The tapered internal guide, or lip, 502 increases the offset quality of both box and end crowns. The wrench 500 is configured such that a grip on a hex nut 506 is retained while wrenching the nut on a protruding hex bolt 504. Once contact is made around a hex nut 506 on a protruding bolt 504, the lip 502 keeps the head centered. Ratcheting is done without false torque or tension. In one embodiment, for example, the angle of the of the tapered internal guide angle relative to the shank is 3°.

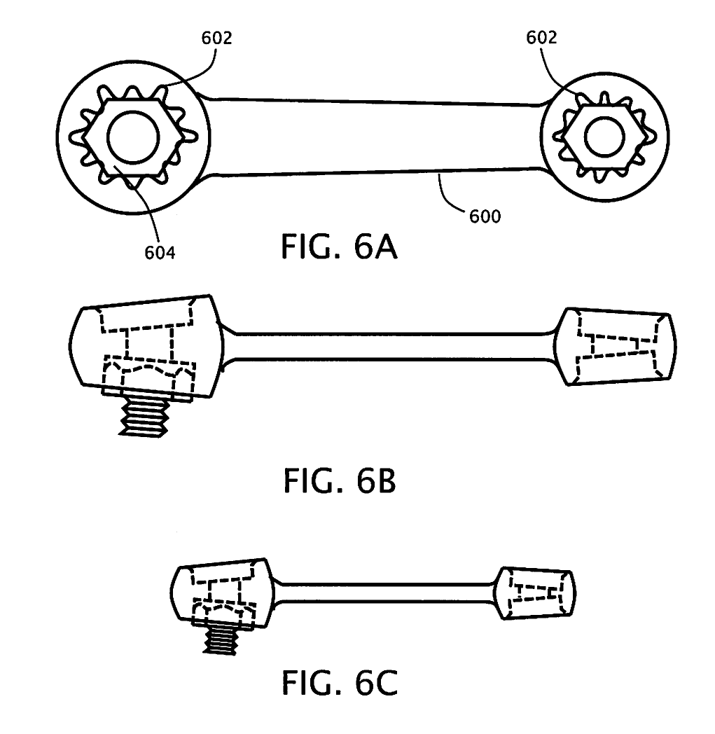

FIG. 6A depicts a schematic view of a duplex box wrench 600 according to one embodiment of the present invention. A wrench with twelve inwardly projecting lobes 602 of the same size within a uniform interior of the duplex wrench 600 is disclosed.

FIGS. 6B through 6D depict duplex box wrench sets according to the present invention.

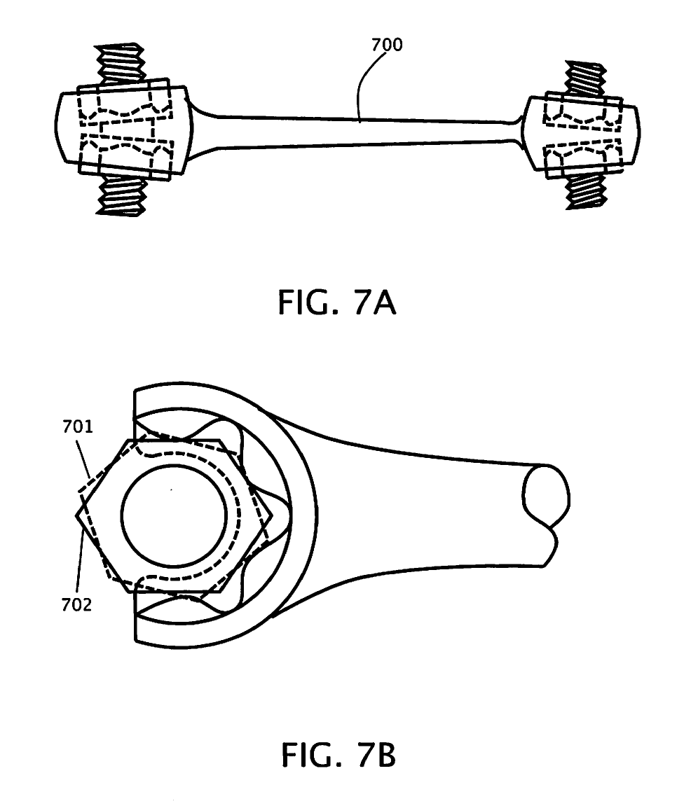

FIGS. 7A & 7B illustrate a duplex wrench 700 having both metric and inch sizes according to one embodiment of the present invention. A duplex wrench 700 for both inch and metric sizes provides additional benefits. The pairing of inch and metric sizes dramatically reduces the number of wrenches needed to work on both measuring systems. For example a hexagonal object 701 measured in inches and a hexagonal object 702 in centimeters can each be engaged by the same duplex wrench.

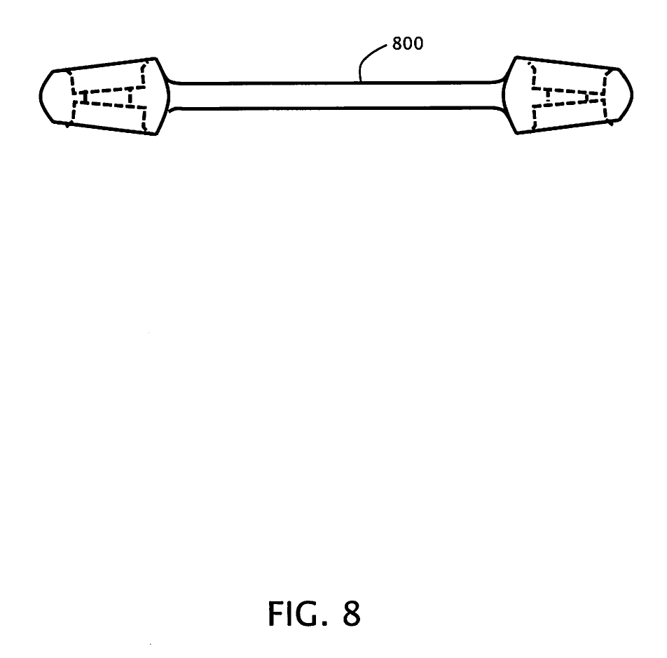

FIG. 8 depicts a duplex wrench 800 measured in inch sizes according to one embodiment of the present invention. A set of different inch sizes will dramatically reduce the number of wrenches needed to work on inch measuring system.

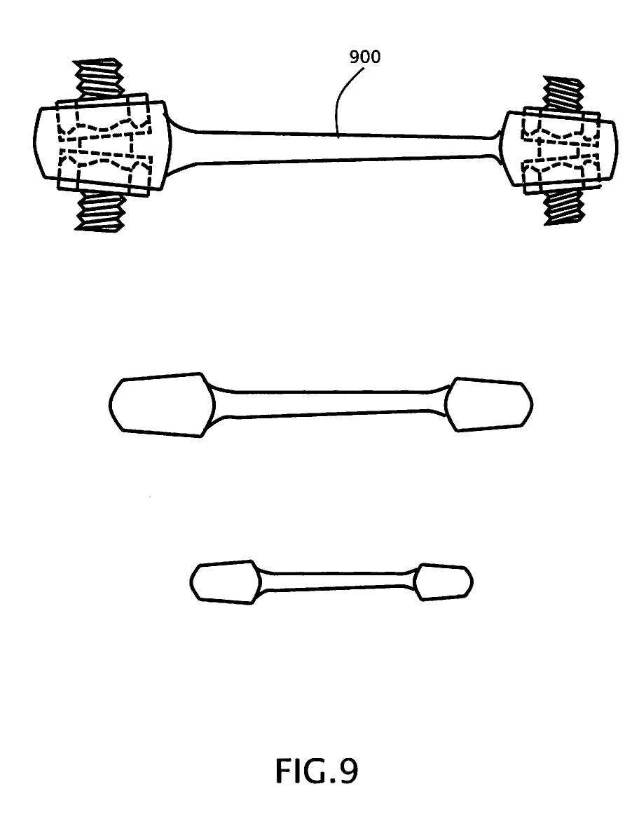

FIG. 9 depicts a duplex wrench 900 measured using the metric system according to one embodiment of the present invention. A set of different metric sizes will dramatically reduce the number of wrenches needed to work on metric measuring system.

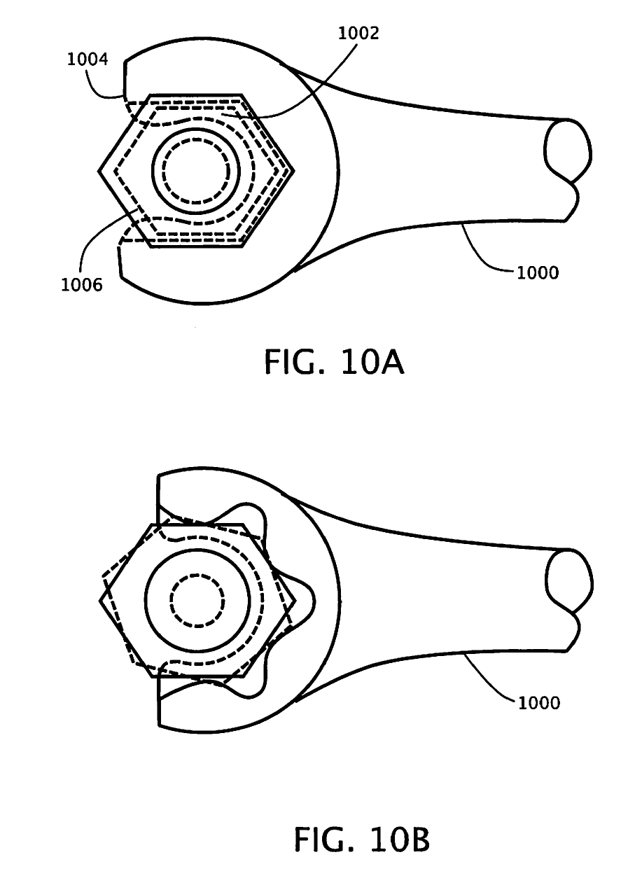

FIGS. 10A & 10B depict an open end duplex wrench 1000 according to one embodiment of the present invention. A tapered internal guide 1002 and jaws with blunt nose 1004 are disclosed. The blunt nose 1004 provides tangential strength to the wrench head when the wrench engages the hex nut 1006.

It will be appreciated by those skilled in the art that the preceding examples and preferred embodiments are exemplary and not limiting to the scope of the present invention. It is intended that all permutations, enhancements, equivalents, and improvements thereto that are apparent to those skilled in the art upon a reading of the specification and a study of the drawings are included within the true spirit and scope of the present invention.

What is claimed is:

1. A single piece rotary wrenching tool, comprising:
a shank;
a first head connected to an end of the shank having a uniform interior without moving parts; and
a second head connected to an opposite end of the shank having a uniform interior without moving parts;
wherein the first head includes a first internal guide separating first and second sides of a two sided crown of the first head, said first internal guide including an aperture defined therethrough;
wherein the second head includes a second internal guide separating first and second sides of a two sided crown of the second head, said second internal guide including an aperture defined therethrough;
wherein each of the first and second sides of the two sided crown of each of the first and second heads includes a plurality of curved surfaces defining a nut receiving space, the plurality of curved surfaces comprising lobes configured to,
when a nut of a certain metric size is received in the nut receiving space, engage hex flats of such a metric nut such that rotation of such a metric nut may be effected without stripping corners of such a metric nut received in the nut receiving space, and
when a nut of a certain SAE size is received in the nut receiving space, engage hex flats of such an SAE nut such that rotation of such an SAE nut may be effected without stripping corners of such an SAE nut received in the nut receiving space;
wherein the first side of the two sided crown of the first head is sized to receive and engage a metric nut of a first size and an SAE nut of a second size;
wherein the second side of the two headed crown of the first head is sized to receive and engage a metric nut of a third size and an SAE nut of a fourth size;
wherein the first side of the two sided crown of the second head is sized to receive and engage a metric nut of a fifth size and an SAE nut of a sixth size; and
wherein the second side of the two sided crown of the second head is sized to receive and engage a metric nut of a seventh size and an SAE nut of an eighth size.

2. The single piece rotary wrenching tool of claim 1, wherein each plurality of curved surfaces includes twelve inwardly projecting lobes configured to exert pressure on flats of a hexagonal object.

3. The single piece rotary wrenching tool of claim 1, wherein each plurality of curved surfaces includes six inwardly projecting lobes configured to exert pressure on flats of a hexagonal object without one or more corners of the hexagonal object engaging one or more corners of the crown.

4. The single piece rotary wrenching tool of claim 1, wherein each of the two sided crowns comprises two joined heads of different sizes.

5. The single piece rotary wrenching tool of claim 1, wherein at least one of the heads is raised.

6. The single piece rotary wrenching tool of claim 1, wherein the aperture of at least one of the internal guides is configured to provide sufficient space for a shaft of a hexagonal bolt to pass through.

7. The single piece rotary wrenching tool of claim 1, wherein at least one of the internal guides is configured to provide constant optimal contact on a hexagonal object.

8. The single piece rotary wrenching tool of claim 1, wherein at least one of the internal guides is configured to maintain the head in a centered orientation relative to a hexagonal nut while ratcheting the nut on a protruding bolt.

9. The single piece rotary wrenching tool of claim 1, wherein the first side of the two sided crown of the first head is angled relative to the shank.

10. The single piece rotary wrenching tool of claim 9, wherein the first side is angled three degrees relative to the shank.

11. The single piece rotary wrenching tool of claim 1, wherein at least one of the two sided crowns is an open-ended two sided crown.

12. A set of three single piece rotary wrenching tools, each single piece rotary wrenching tool comprising:
a first head having a first two sided crown and a first internal guide;
a second head having a second two sided crown and a second internal guide; and
a shank connecting the first head and the second head;
wherein each side of each two sided crown is configured to be used with both SAE sized bolts and metric sized bolts;
wherein the set of three single piece rotary wrenching tools is capable to receive and engage, via the two sided crowns, twelve sizes of SAE bolts and twelve sizes of metric bolts.
